(19) United States
(12) Patent Application Publication
(10) Pub. No.: US 2007/0171575 A1
(43) Pub. Date: Jul. 26, 2007

(54) Perpendicular magnetic recording medium with controlled damping property of soft magnetic underlayer

(75) Inventors: Chee-kheng Lim, Yongin-si (KR); Eun-sik Kim, Yongin-si (KR); Hoon-sang Oh, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/657,595

(22) Filed: Jan. 25, 2007

(30) Foreign Application Priority Data
Jan. 25, 2006 (KR) 10-2006-0007906

(51) Int. Cl. G11B 23/03

(52) U.S. Cl. 360/133

(57) ABSTRACT

A perpendicular magnetic recording medium is provided. The perpendicular magnetic recording medium includes a soft magnetic underlayer, a recording layer formed on the soft magnetic underlayer, and a damping control layer which controls a damping constant of the soft magnetic underlayer.

### CROSS-REFERENCE TO RELATED PATENT APPLICATIONS

This application claims priority from Korean Patent Application No. 10-2006-0007906, filed on Jan. 25, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a perpendicular magnetic recording medium and, more particularly, to a perpendicular magnetic recording medium with a controlled damping property of a soft magnetic underlayer.

2. Description of the Related Art

Recently, as the demand for recording devices that are small-sized but with a large capacity recording density has increased, the demand for magnetic recording media having a high recording density has increased. A perpendicular magnetic recording medium has been proposed in order to increase a surface recording density of a magnetic recording medium. The perpendicular magnetic recording medium increases the surface recording density by magnetizing a recording layer in a perpendicular direction. The recording layer of the perpendicular magnetic recording medium is formed of a magnetic material having not only a relatively high magnetic anisotropy but also a relatively high coercivity.

FIG. 1A illustrates a sectional view of a related art magnetic recording device, i.e., a magnetic recording head and a vertical magnetic recording medium.

Referring to FIG. 1A, a perpendicular magnetic recording medium 10 includes a soft magnetic underlayer 11, an intermediate layer 13 and a recording layer 15 that are successively formed. A protective layer and/or lubrication layer may be further formed on the recording layer 15. The information recording is performed by locating a magnetic head 20 on the perpendicular magnetic recording medium 10, and magnetizing the recording layer 15.

The operation of recording information on the perpendicular magnetic recording medium 10 as depicted in FIG. 1A will now be described. A magnetic flux radiating from a main pole 21 magnetizes the recording layer 15 into bit region units, is incident on the soft magnetic underlayer 11 under the recording layer 15, and is then returned to a return pole 25 associated with the main pole 21. As shown in FIG. 1A, a mirror image of the magnetic head 20 exists on the soft magnetic underlayer 11. The mirror image is called a head image.

As the width of the main pole 21 of the magnetic head 20 is reduced in order to increase the recording track density, a recording field strength is highly reduced. In the case of a material having a relatively high saturation magnetization value, the maximum recording field strength is about 4πMs where Ms is the saturation magnetization. In the perpendicular magnetic recording medium of FIG. 1A, a recording field of the soft magnetic underlayer 11 advantageously assists the recording field from the main pole thereby to increase the overall recording field. That is, the recording field becomes the sum total of the recording field radiated from the magnetic head 20 and the recording field generated from the soft magnetic underlayer 11. The recording field generated from the soft magnetic underlayer 11 depends on not only the property of the material but also on the thickness of the soft magnetic underlayer 11. That is, the recording field generated from the soft magnetic underlayer 11 depends on the damping constant of the soft underlayer.

That is, the damping constant α is defined by the following equation 1 that is called the Landau-Liftshitz equation.

∂M/∂t=−γM×Heff+(α/Ms)M×∂M/∂τ [Equation 1]
M: magnetization,
Heff: effective magnetic field,
γ: gyromagnetic ratio,
α: damping constant,
τ: time

The damping constant α represents the dissipating rate of energy accumulated from the field of the magnetic head 20 in the soft magnetic underlayer 11.

FIG. 1B is a schematic graph illustrating the fields of the soft magnetic underlayers of different damping constants with respect to time when the field from the magnetic head 20 is applied to the soft underlayer 11. Referring to FIG. 1B, it can be noted that, when the soft magnetic underlayer 11 has a relatively low damping constant, the soft magnetic underlayer 11 saturates very quickly. In this case, the saturated soft underlayer will prevent further flow of magnetic flux from the main pole to the soft underlayer and therefore deteriorate the recording field gradient profile. It can also be noted that, when the soft magnetic underlayer 11 has a relatively high damping constant, the soft magnetic underlayer 11 saturates slowly. In this case, the slow response of the soft underlayer reduces the recording field contribution from the soft underlayer. The optimum condition is when the damping constant of the soft underlayer is properly controlled so that the recording field rise time from the soft underlayer is matched with the recording field from the main pole. When the soft magnetic underlayer 11 is formed of a ferromagnetic substance such as Co, CoFe or NiFe, the relatively low damping constant of about 0.01-0.02 can be obtained. Therefore, it is a factor to properly control the damping constant of the soft magnetic underlayer 11 and the soft magnetic underlayer 11 can perform a similar action as the field value of the magnetic head 20.

### SUMMARY OF THE INVENTION

The present invention provides a perpendicular magnetic recording medium having an improved information recording property and having a high recording field by controlling a damping property of a soft magnetic underlayer.

The present invention also provides a method of controlling a damping property of a soft magnetic underlayer of a perpendicular magnetic recording medium.

According to an aspect of the present invention, there is provided a perpendicular magnetic recording medium, including: a soft magnetic underlayer; a recording layer formed on the soft magnetic underlayer; and a damping control layer which controls a damping constant of the soft magnetic underlayer.

The damping control layer may be formed between the soft magnetic underlayer and the recording layer.

The damping control layer may be formed in a surface of the soft magnetic underlayer.

A damping constant of the damping control layer may be in the range of about 0.03 to 0.08.

The thickness of the damping control layer may be in the range of about 1 to 50 nm.

The damping control layer may be formed of a material selected from Os, Nb, Ru, Rh, Ta, Pt, Tb, Zr and an alloy thereof. Alternatively, the damping control layer is formed of an alloy of a material forming the soft magnetic underlayer and a material selected from Os, Nb, Ru, Rh, Ta, Pt, Tb, and Zr.

The damping control layer may be formed by using 1-10% of one or more materials selected from Os, Nb, Ru, Rh, Ta, Pt, Tb or Zr to be contained in the material forming the soft magnetic underlayer.

The soft magnetic under layer may be formed on a seed layer formed on a substrate.

### BRIEF DESCRIPTION OF THE DRAWINGS

The above and other features and advantages of the present invention will become more apparent by describing in detail exemplary embodiments thereof with reference to the accompanying drawings, in which:

FIG. 1A is a sectional view of a related art magnetic recording device, i.e., a magnetic recording head and a vertical magnetic recording medium.

FIG. 1B is a schematic graph illustrating a variation of the fields of soft magnetic underlayers having different damping constants with respect to time;

FIG. 2A is a sectional view of a perpendicular magnetic recording medium including a soft magnetic underlayer exhibiting a controlled damping property, according to an exemplary embodiment of the present invention;

FIG. 2B illustrates a sectional view of a perpendicular magnetic recording medium having a controlled damping property of a soft magnetic underlayer according to another exemplary embodiment of the present invention;

FIG. 2C is a view illustrating a doping process used in forming the damping control layer on the soft magnetic underlayer of FIG. 2B, according to an exemplary embodiment of the present invention;

FIGS. 3A and 3B are graphs illustrating simulated variations in the recording fields of a soft magnetic underlayer when a recording field (see solid line) is applied from a magnetic head;

FIG. 4A is a graph illustrating a variation in the field value of the soft magnetic underlayer with respect to time when the damping constant of the damping control layer is 0.05, in which a transition time for transiting a field direction is illustrated;

FIG. 4B is a graph illustrating a transition time with respect to the damping constant of the damping control layer; and

FIG. 5 is a graph illustrating variations in the field value of the soft magnetic underlayer with respect to time when the thickness of each of the soft magnetic underlayer and the damping control layer varies.

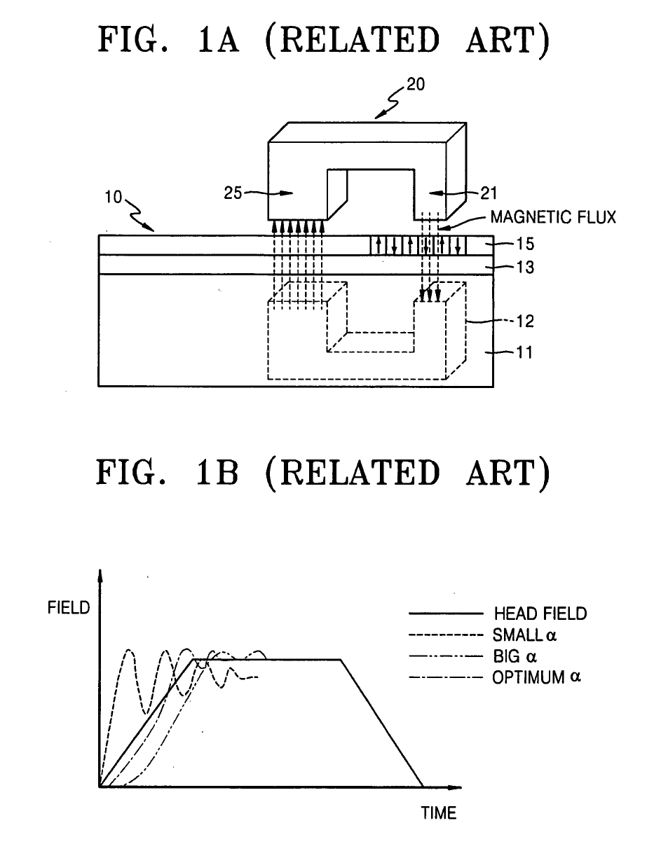

### DETAILED DESCRIPTION OF EXEMPLARY EMBODIMENTS OF THE INVENTION

The present invention will now be described more fully with reference to the accompanying drawings, in which exemplary embodiments of the invention are shown.

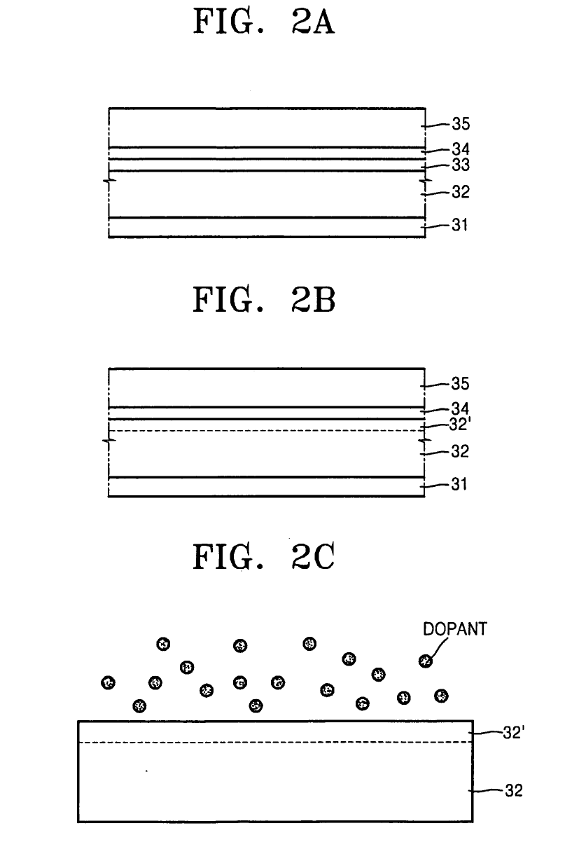

FIG. 2A is a sectional view of a perpendicular magnetic recording medium including a soft magnetic underlayer exhibiting a controlled damping property, according to an exemplary embodiment of the present invention. Referring to FIG. 2A, a perpendicular magnetic recording medium according to this embodiment includes a substrate 31, and a soft magnetic underlayer 32, a damping control layer 33, an intermediate layer 34, and a recording layer 35 that are successively formed on the substrate 31. The intermediate layer 34 may be selectively omitted. A seed layer (not shown) may be further formed between the substrate 31 and the soft magnetic underlayer 32. A protective layer (not shown) may be further formed on the recording layer 35.

The substrate 31, the seed layer, the intermediate layer 34, and the recording layer 35 may be formed of conventional materials. For example, but not limited thereto, the substrate 31 may be formed of glass. The seed layer may be formed of Ta, a Ta alloy, a Ta/Ru compound, or NiFeCr. The intermediate layer may be formed of Cu, Ru, Pd or Pt. The recording layer may be formed of FePt, CoPt or CoPd through an alloy target or by a cosputtering process. The recording layer may be formed in a multi-layer such as a Fe/Pt layer, a Co/Pt layer or a Co/Pd layer. Selectively, the recording layer may contain additive materials such as C, Ag, W, Ti, B, Ta, Ru, Cr, Mn, Y, N, O, Pt, Cu, Mn₃Si, Si, Nb, Ni, Fe, Au, Co or Zn. The recording layer may further contain matrix materials such as Al₂O₃, SiO₂, B₂O₃, C₄F₈, Si₃N₄, SiN, BN, ZrO, TaN or other oxide materials.

The soft magnetic underlayer 32 may be formed of a ferromagnetic substance having a relatively small coercivity or an alloy such as Co, CoZrNb, CoNiZr, NiZr, NiFe, CoFeB, CoTaZr, Co₉₀Fe₁₀ or Co₃₅Fe₆₅. The damping control layer 33 is formed to improve the damping property of the soft magnetic underlayer 32. The damping control layer 33 may be formed of Os, Nb, Ru, Rh, Ta, Pt, Tb, Zr or an alloy thereof. The thickness of the damping control layer 33 may be within a range of 1-50 nm.

FIG. 2B illustrates a sectional view of a perpendicular magnetic recording medium including a soft magnetic underlayer exhibiting a controlled damping property, according to another exemplary embodiment of the present invention.

Referring to FIG. 2B, a perpendicular magnetic recording medium according to the present embodiment includes a substrate 31, and a soft magnetic underlayer 32, a damping control layer 32′, an intermediate layer 34, and a recording layer 35 that are successively formed on the substrate 31. The intermediate layer 34 may be selectively omitted. A seed layer (not shown) may be further formed between the substrate 31 and the soft magnetic underlayer 32. A protective layer may be further formed on the recording layer 35.

Similar to the exemplary embodiment illustrated in FIG. 2A, the soft magnetic underlayer 32 may be formed of a magnetic material such as Co, CoZrNb, CoNiZr, NiFe, CoFeB, CoTaZr, Co₉₀Fe₁₀, or Co₃₅Fe₆₅. The damping control layer 32′ is formed to improve the damping property of the soft magnetic underlayer 32. Unlike the damping control layer 33 of FIG. 2A, as shown in FIG. 2C, the damping control layer 32′ of the present embodiment is formed by doping rare earth metal or transition metal such as Os, Nb, Ru, Rh, Ta, Pt, Tb or Zr on the soft magnetic underlayer 32 through a doping process. Alternatively, the damping control layer 32′ may be formed by coating Os, Nb, Ru, Rh, Ta, Pt, Tb or Zr on the soft magnetic underlayer 32 through a cosputtering process.

The damping control layer 32′ in FIG. 2B is formed by using 1-10% of one or more of the materials selected from Os, Nb, Ru, Rh, Ta, Pt, Tb or Zr to be contained in the material forming the soft magnetic underlayer 32. The thickness of the damping control layer 32′ may be within a range of 1-50 nm.

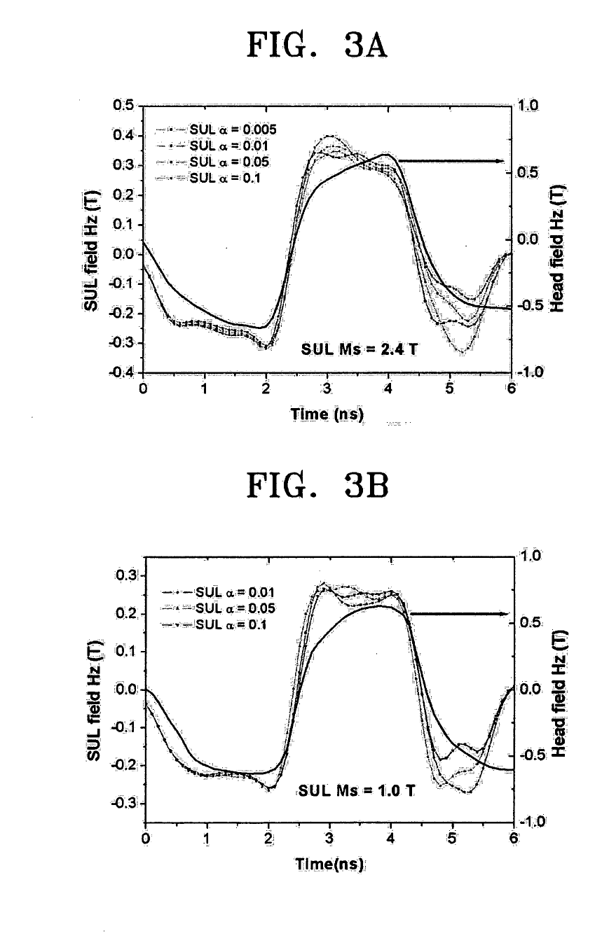

FIGS. 3A and 3B are graphs illustrating simulated variations in the recording fields of the soft magnetic under layer 32 and the damping control layers 32′ and 33 when the soft magnetic under layer 32 is formed of Co, CoFe or NiFe and has a damping constant α of 0.02 and a thickness of 85 nm and the damping control layers 32′ and 33 are controlled to have a thickness of 15 nm and a damping constant between 0.005-0.3.

The graph of FIG. 3A illustrates a case when a saturation magnetization value of the soft magnetic underlayer 32 is 2.4 T and the graph of FIG. 3B shows a case when a saturation magnetization value of the soft magnetic underlayer 32 is 1.0 T.

Referring to FIG. 3A, the graph shows simulations when the damping constant α of each damping control layer 32′ and 33 is 0.005, 0.01, 0.05 and 0.1. It can be noted through the graph in FIG. 3A that when the recording values of the magnetic head dramatically increase or decrease, field values of the soft magnetic underlayer 32 and the damping control layers 32′ and 33 also dramatically increase or decrease. Note that when the field value dramatically increases after 2 ns have lapsed, the increase rate of the soft magnetic underlayer field values, i.e., the transition gradient is highest when the damping constant α of each damping control layer 32′ and 33 is 0.05. This can be also identified in the graph of FIG. 3B. Note that when the saturation magnetization value of the soft magnetic underlayer is 1.0T, the transition gradient is highest when the damping constant α of each damping control layer 32′ and 33 is 0.05. That is, it can be noted that the optimum damping constant α of each damping control layer 32′ and 33 is 0.05.

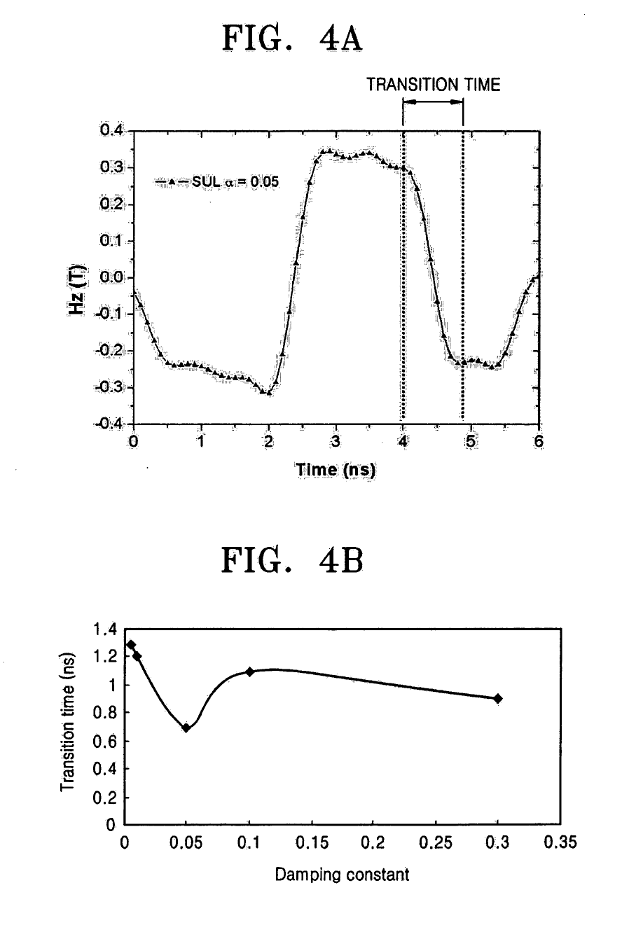

FIG. 4A is a graph illustrating a variation in the field value of the soft magnetic underlayer with respect to time when the damping constant α of each damping control layer 32′ and 33 is 0.05.

In order to define a preferable range of the damping constant α with reference to the optimum damping constant α of 0.05, the period of time the soft magnetic underlayer 32 transits from the highest field value to the lowest field value is defined as a transition time. When the damping constant α of each damping control layer 32′ and 33 is 0.05, the transition time is about 0.7 ns. Then, the transition time is estimated and compared as the damping constant of the damping control layers 32′ and 33 varies, as shown in FIG. 4B.

FIG. 4B is a graph illustrating a transition time with respect to the damping constant of the damping control layer. Referring to FIG. 4B, the transition time is shortest when the damping constant of each damping control layer 32′ and 33 is 0.05. When the damping constant is less than or greater than 0.05, the transition time increases. That is, it can be noted that the shorter the transition time, the higher the recording density. Therefore, the preferable range of the damping constant of the soft magnetic underlayer may be between 0.03-0.08 since the soft magnetic underlayer has a good property in terms of a higher recording density in the case where the transition time is less than Ins.

When the soft magnetic underlayer is formed of NiFe, even when doping conditions may differ, the damping constant of the soft magnetic underlayer may vary within a range of 0.03-0.08 by doping with rare earth metals such as Tb and Gd. When the transition metal such as Os is used when doping, the damping constant of the soft magnetic underlayer may be within a range of 0.01-0.1 by varying a doping density. However, it is noted that the increase of the doping density reduces the saturation magnetization value of the soft magnetic underlayer.

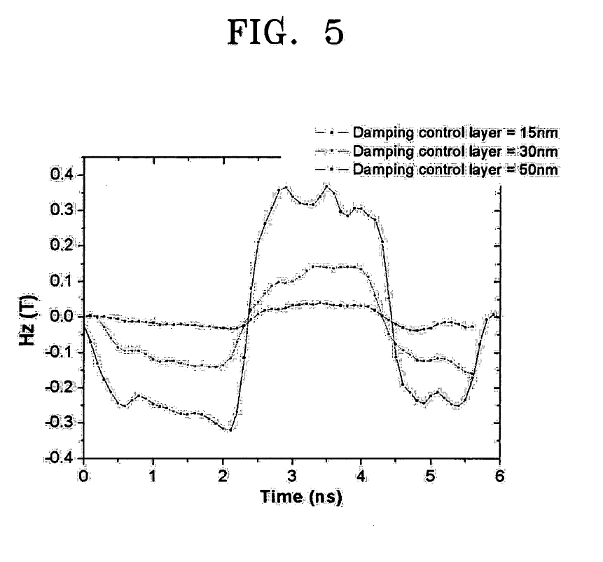

FIG. 5 is a graph illustrating variations in a recording field value of the soft magnetic underlayer 32 with respect to time when the thickness of each of the soft magnetic underlayer 32 and the damping control layers 32′ and 33 varies.

Referring to FIG. 5, the graph shows a case when the soft magnetic underlayer 32 has a thickness of 85 nm, 70 nm and 50 nm and a damping constant of 0.02 and each damping control layer 32′ and 33 formed on the soft magnetic underlayer 32 has a thickness of 15 nm, 30 nm and 50 nm. Referring to FIG. 5, when the thickness of each damping control layer 32′ and 33 is greater than 50 nm, the recording field value of the soft magnetic underlayer 32 becomes poor. Therefore, when each damping control layer 32′ and 33 is formed on the soft magnetic underlayer 32, a thickness of each damping control layer 32′ and 33 may be set within a range of 1-50 nm, and preferably a range of 5-30 nm, and more preferably a range of 5-20 nm.

Consistent with the present invention, since the damping control layer is formed while being able to control the damping constant of the soft magnetic underlayer of the perpendicular magnetic recording medium, the recording field value of the perpendicular magnetic recording medium can be optimized. In addition, a problem is solved for when the recording field value is dramatically reduced when the width of the magnetic recording head decreases.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A perpendicular magnetic recording medium, comprising:
a soft magnetic underlayer;
a recording layer formed on the soft magnetic underlayer; and
a damping control layer which controls a damping constant of the soft magnetic underlayer.

2. The perpendicular magnetic recording medium of claim 1, wherein the damping control layer is formed between the soft magnetic underlayer and the recording layer.

3. The perpendicular magnetic recording medium of claim 1, wherein the damping control layer is formed in a surface of the soft magnetic underlayer.

4. The perpendicular magnetic recording medium of claim 2, wherein a damping constant of the damping control layer is in the range of about 0.03 to 0.08.

5. The perpendicular magnetic recording medium of claim 2, wherein the thickness of the damping control layer is in the range of about 1 to 50 nm.

6. The perpendicular magnetic recording medium of claim 2, wherein the damping control layer is formed of a material selected from Os, Nb, Ru, Rh, Ta, Pt, Tb, Zr and an alloy thereof.

7. The perpendicular magnetic recording medium of claim 3, wherein the damping control layer is formed of an alloy of a material forming the soft magnetic underlayer and a material selected from Os, Nb, Ru, Rh, Ta, Pt, Tb, and Zr.

8. The perpendicular magnetic recording medium of claim 7, wherein the damping control layer is formed by using 1-10% of one or more of the materials selected from Os, Nb, Ru, Rh, Ta, Pt, Tb or Zr to be contained in the material forming the soft magnetic underlayer.

9. The perpendicular magnetic recording medium of claim 1, wherein the soft magnetic underlayer is formed on a seed layer formed on a substrate.

10. The perpendicular magnetic recording medium of claim 3, wherein a damping constant of the damping control layer is in the range of about 0.03 to 0.08.

11. The perpendicular magnetic recording medium of claim 3, wherein the thickness of the damping control layer is in the range of about 1 to 50 nm.
